(19) United States
(12) Patent Application Publication
(10) Pub. No.: US 2019/0174897 A1
(43) Pub. Date: Jun. 13, 2019

(54) OVERMOLDING MOLD DEVICE OF COSMETIC VESSEL

(71) Applicant: SAMHWA P&T CO., LTD., Uiwang-si (KR)

(72) Inventor: Kyung Chang LEE, Gyeonggi-do (KR)

(21) Appl. No.: 15/849,209

(22) Filed: Dec. 20, 2017

(30) Foreign Application Priority Data
Dec. 13, 2017 (KR) 10-2017-0170912

(51) Int. Cl. A45D 34/00; B29C 44/12; B29C 49/20

(52) U.S. Cl. CPC A45D 34/00; B29C 49/061; B29C 49/20; B29C 44/1271

(57) ABSTRACT

Disclosed is an overmolding mold device of a cosmetic vessel including an upper mold of which a raw material injecting device is inserted into a central upper portion and a cavity having an outer shape of the cosmetic vessel is formed at the lower inner side, and a cosmetic vessel made of glass to which a bottleneck portion is inserted downward as a member which is inserted into the cavity formed concavely at the lower portion of the upper mold.

### CROSS-REFERENCE TO RELATED APPLICATION

This application claims under 35 U.S.C. § 119(a) the benefit of Korean Patent Application No. 10-2017-0170912 filed on, the entire contents of which are incorporated herein by reference.

### BACKGROUND

### (a) Technical Field

The present invention relates to an overmolding mold device of a cosmetic vessel and more particularly, to an overmolding mold device of a cosmetic vessel capable of preventing breakage of the vessel at the time of overmolding of the cosmetic vessel such as a perfume bottle.

### (b) Background Art

Overmolding or multi-component molding has been widely used in an injection molding industry. The overmolding is basically limited to a process of producing a completed component having two or more thermoplastic base resins by injection molding. A method in the case of two overmolding components is known as bi-injection molding. The overmolding has been used in a cable industry for many years and it has been found that interest in the overmolding is increasing in an industrial field and a consumer product industry. In these industries, many applications combine soft touch materials into rigid components. The soft touch material provides an improved appearance, a good contact property, and an improved gripping capability. The most widely used method for combining the soft material and the rigid material is overmolding on the surface of a finished product such as a vessel.

Traditionally, direct overmolding of the soft material on the rigid material forms a finished product part. It is preferable to provide a technique of applying the soft touch material on the rigid vessel at the time of producing the vessel. This is a part of the present invention. An overmolded layer is applied to a vessel perform which is a part of the exterior of the vessel after the overmolded layer is blow-molded.

A significant improvement of the gripping capability may be achieved with a combination of an improved grip design on the vessel and overmolding of the grip design area that enhances the grip of the vessel. An object of the present invention is to improve gripping of a vessel by improving a grip portion formed in the vessel as an integrated part of the vessel. It is especially important for a vessel for a personal health care product in which an outer surface of the vessel and the personal hand may have soap layers in addition to the vessel and the personal wet hand. The soap is a well-known lubricant. The forming of the grip portion on the vessel and the overmolding of the grip portion of the vessel significantly reduce the drop of the vessel which has been used in a humid environment. This is an effect of the combination of the grip portion on the vessel and the overmolded material.

Accordingly, in a packaging industry, in order to form a vessel having an improved gripping function and/or other different functions, it is also required to achieve the design characteristic without adversely affecting PET or other thermoplastic recycling steams. Further, in the packaging industry, it is required to produce an effective vessel in terms of costs.

### SUMMARY OF THE DISCLOSURE

The present invention has been made in an effort to provide an overmolding mold device of a cosmetic vessel which prevents breakage of the vessel at the time of overmolding of the cosmetic vessel such as a perfume bottle.

A first exemplary embodiment of the present invention provides an overmolding mold device of a cosmetic vessel including an upper mold of which a raw material (injection material) injecting device is inserted into a central upper portion and a cavity having an outer shape of the cosmetic vessel is formed at the lower inner side; a cosmetic vessel made of glass to which a bottleneck portion is inserted downward, as a member which is inserted into the cavity formed concavely at the lower portion of the upper mold; a lower mold which is in contact with a lower surface of the upper mold; and a vessel breakage preventing means which prevents the cosmetic vessel made of glass from being broken at the time of overmolding of the outer shape of the cosmetic vessel while inserted to the bottleneck portion of the cosmetic vessel made of glass, as a member inserted into the lower mold.

Herein, the vessel breakage preventing means may include a deformable rubber which is inserted to the inner periphery of the bottleneck portion of the cosmetic vessel made of glass to buffer the bottleneck portion; a pin of which an upper end is inserted to the center of the rubber and a lower end is fixed into the lower mold; and a fixing guide portion which prevents the rubber from descending and supports the lower surface of the bottleneck portion of the cosmetic vessel made of glass.

According to the overmolding mold device of the cosmetic vessel of the present invention, a rubber is inserted and guided to an inner periphery of a bottleneck portion of the cosmetic vessel made of glass to prevent the cosmetic vessel from being broken.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a cross-section view illustrating an overmolding mold device of a cosmetic vessel of the present invention, and

FIG. 2 is a cross-section view illustrating an operation of the overmolding mold device of the cosmetic vessel of the present invention.

### DETAILED DESCRIPTION

Hereinafter, preferred embodiments of the present invention will be described with reference to the accompanying drawings so that those skilled in the art can easily implement the present invention. It should be noted that reference numerals denoted in configurations in the accompanying drawings use like reference numerals as possible when denoting like configurations even in other drawings. Further, in describing the present invention, detailed description of associated known function or constitutions will be omitted if it is determined that they unnecessarily make the gist of the present invention unclear. In addition, any features shown in the drawings are enlarged, reduced, or simplified for ease of description and the drawings and constituent elements thereof are not necessarily illustrated at appropriate ratios. However, these details will be easily understood to those skilled in the art.

Terms including an ordinary number, such as ‘first’ and ‘second’, are used for describing various constituent elements, but the constituent elements are not limited by the terms. The terms are used only to discriminate one constituent element from another component. For example, a first constituent element may be named as a second constituent element and similarly, the second constituent element may be named as the first constituent element without departing from the scope of the present invention. The term ‘and/or’ includes a combination of a plurality of associated disclosed items or any item of the plurality of associated disclosed items.

Further, relative terms described based on those illustrated in the drawings such as ‘front surface’, ‘rear surface’, ‘upper surface’ and ‘lower surface’ may be replaced with ordinals such as ‘first’ and ‘second’.

In the ordinals such as ‘first’ and ‘second’, the order may be an aforementioned order or arbitrarily defined, and the order may be arbitrarily changed if necessary.

Terms used in the present invention are used only to describe specific exemplary embodiments, and are not intended to limit the present invention. A singular form may include a plural form if there is no clearly opposite meaning in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

If it is not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

Hereinafter, a preferable embodiment of the present invention will be described in detail with reference to the accompanying drawings. Moreover, in the following description, a detailed explanation of related known configurations or functions may be omitted to avoid obscuring the subject matter of the present invention.

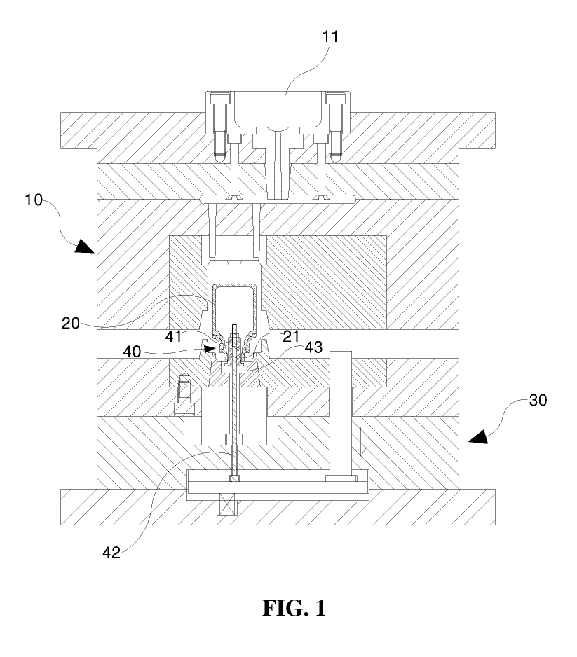

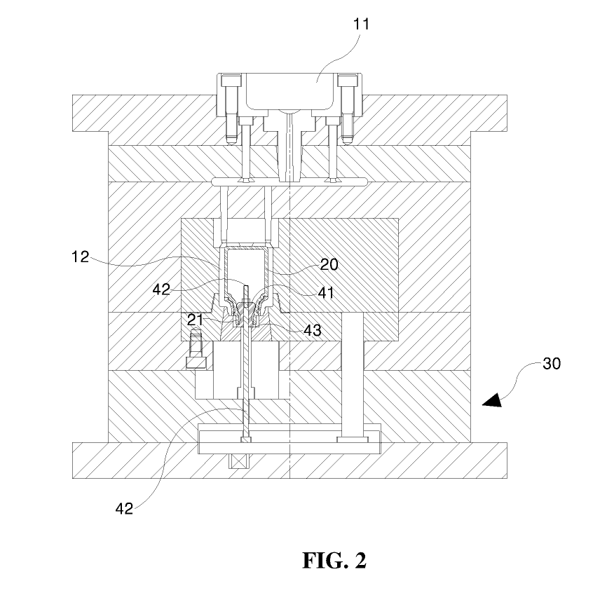

FIG. 1 is a cross-section view illustrating an overmolding mold device of a cosmetic vessel of the present invention and FIG. 2 is a cross-section view illustrating an operation of the overmolding mold device of the cosmetic vessel of the present invention.

As illustrated in FIGS. 1 and 2, an overmolding mold device of the cosmetic vessel of the present invention includes an upper mold 10 of which a raw material (injection material) injecting device 11 is inserted into a central upper portion and a cavity 12 having an outer shape of the cosmetic vessel is formed at the lower inner side; a cosmetic vessel 20 made of glass to which a bottleneck portion 21 is inserted downward, as a member which is inserted into the cavity 12 formed concavely at the lower portion of the upper mold 10; a lower mold 30 which is in contact with a lower surface of the upper mold 10; and a vessel breakage preventing means 40 to prevent the cosmetic vessel 20 made of glass from being broken at the time of overmolding of the outer shape of the cosmetic vessel 20 while inserted to the bottleneck portion 21 of the cosmetic vessel 20 made of glass, as a member inserted into the lower mold 30.

The vessel breakage preventing means 40 includes a deformable rubber 41 which is inserted to the inner periphery of the bottleneck portion, that is, an inlet portion of the cosmetic vessel 20 made of glass to buffer the bottleneck portion, a pin 42 of which an upper end is inserted to the center of the rubber 41 and a lower end is fixed into the lower mold 30, and a fixing guide portion 43 which prevents the rubber 41 from descending and supports the lower surface of the bottleneck portion 21 of the cosmetic vessel 20 made of glass.

Next, the operation and effect of the overmolding mold device of the cosmetic vessel of the present invention configured as described above will be described.

First, the pin 42 is uprightly fixed to the lower mold 30 and a cylindrical rubber 41 is fixed to the upper end of the pin 42.

In addition, the rubber 41 fixed to the upper end of the fin 42 is inserted into the bottleneck portion 21 by overturning the cosmetic vessel 20 made of glass to be positioned at the inner periphery of the bottleneck portion 21.

Thereafter, when the lower mold 30 and the upper mold 10 are in contact with each other, the fixing guide portion 43 of the lower mold 30 pushes the lower surface of the rubber 41 upward. As such, when the rubber 41 is pushed upward, the rubber 41 has an increased inner diameter to be firmly in contact with the inner periphery of the bottleneck portion 21.

In such a state, when the injection material is injected through the raw material (injection material) injecting device 11, the injection material is overmolded in the cavity 12 of the outer shape of the cosmetic vessel.

As such, the cosmetic vessel 30 made of glass is broken by a molding temperature of the injection material at the time of overmolding, and the vessel breakage preventing means 40, that is, the cylindrical rubber 41 is firmly in contact with the inner periphery of the bottleneck portion 21 of the cosmetic vessel 20 to prevent breakage of the cosmetic vessel 20 made of glass.

As described above, detailed embodiments have been described in the detailed description of the present invention, but a possibility that the technology of the present invention will be easily modified and executed by those skilled in the art is apparent and the modified embodiments will be included in the technical spirit disclosed in the appended claims of the present invention.

What is claimed is:

1. An overmolding mold device of a cosmetic vessel, comprising:
an upper mold 10 in which a raw material (injection material) injecting device 11 is inserted into a central upper portion thereof and a cavity 12 having an outer shape of the cosmetic vessel is formed at the lower inner side thereof;
a cosmetic vessel 20 made of glass to which a bottleneck portion 21 is inserted downward, as a member which is inserted into the cavity 12 formed concavely at the lower portion of the upper mold 10;
a lower mold 30 which is in contact with a lower surface of the upper mold 10; and
a vessel breakage preventing means 40 which prevents the cosmetic vessel 20 made of glass from being broken at the time of overmolding of the outer shape of the cosmetic vessel 20 while inserted to the bottleneck portion 21 of the cosmetic vessel 20 made of glass, as a member inserted into the lower mold 30.

2. The overmolding mold device of the cosmetic vessel of claim 1, wherein the vessel breakage preventing means 40 includes
a deformable rubber 41 which is inserted to the inner periphery of the bottleneck portion of the cosmetic vessel 20 made of glass to buffer the bottleneck portion;
a pin 42 of which an upper end is inserted to the center of the rubber 41 and a lower end is fixed into the lower mold 30; and
a fixing guide portion 43 which prevents the rubber 41 from descending and supports the lower surface of the bottleneck portion 21 of the cosmetic vessel 20 made of glass.
